(19) United States
(12) Patent Application Publication
(10) Pub. No.: US 2020/0192255 A1
(43) Pub. Date: Jun. 18, 2020

(54) FIXING DEVICE AND IMAGE FORMING APPARATUS

(71) Applicant: KYOCERA Document Solutions Inc., Osaka (JP)

(72) Inventor: Shinji YAMANE, Osaka-shi (JP)

(73) Assignee: KYOCERA Document Solutions Inc., Osaka (JP)

(21) Appl. No.: 16/695,302

(22) Filed: Nov. 26, 2019

(30) Foreign Application Priority Data
Dec. 13, 2018 (JP) 2018-233800

(51) Int. Cl. G03G 15/20; G03G 21/16

(52) U.S. Cl. CPC G03G 15/2032; G03G 15/2092; G03G 2215/2032; G03G 15/2028; G03G 21/1647

(57) ABSTRACT

A fixing device includes a fixing member, a separation craw. The fixing member heats a toner image on a sheet while rotating around an axis. The separation claw comes into contact with a surface of the fixing member and separates the sheet from the surface of the fixing member. The separation claw has an opposing face facing the sheet. The opposing face has a tip end portion coming into contact with the surface of the fixing belt. The opposing face is formed to be asymmetry with respect to a conveyance direction along which the sheet is conveyed from the tip end portion.

### INCORPORATION BY REFERENCE

This application is based on and claims the benefit of priority from Japanese patent application No. 2018-233800 filed on Dec. 13, 2018, which is incorporated by reference in its entirety.

### BACKGROUND

The present disclosure relates to a fixing device which fixes a toner on a sheet and an image forming apparatus including the fixing device.

An electrophotographic type printer is provided with a fixing device which fixes a toner on a sheet. The fixing device includes a fixing member (a fixing roller, a fixing belt or the like), a pressing roller and a heating part (a halogen heater, a ceramic heater, an induction heating heater or the like), and a pressing area through which the sheet is held and conveyed is formed between the fixing member and the pressing roller. The heating part heats the fixing member, and the toner is heated and pressed at the pressing area to be fixed on the sheet.

The fixing device including a separation claw which assists a separation of the sheet from the fixing member is known. The separation claw has a wedge-shaped tip end portion, and is disposed on the downstream side of the pressing area in the sheet conveyance direction. The tip end portion of the separation claw is pressed against the outer circumferential face of the fixing member to separate the adhered sheet from the fixing member.

However, in some cases, a part of the toner is transferred to the fixing member from the sheet without being fixed on the sheet, then to the separation claw from the fixing member and is accumulated on the separation claw. The accumulated toner may become a lump of the toner to cause a deterioration of the sheet conveyance performance and a contamination of the sheet.

Then, a technique for suppress the accumulation of the toner on the separation claw is discussed. For example, a sheet separation claw is discussed, which has a body part through which a supporting shaft is inserted, a recessed part extending from the upper portion of the body part and a sliding part extending on the tip side of the recessed part and having a tip edge sliding on a surface of a roller, and the upper face of the recessed part is formed in a mountain-like shape. Additionally, the separation claw having a tip width of 1 mm or smaller is also discussed. Furthermore, it is discussed to provide a step portion on an opposite face to a separation claw guide face, in which the step portion is recessed in a direction far from a rotational body at a position separated rearward by a predetermined distance from the tip portion of the separation claw.

However, in the above described sheet separation claw, because a wide portion remains near the sliding part, the lump of toner formed on this portion may remain as it is and then grow. Furthermore, if the tip width of the separation claw is made to be narrow as described above, a contact force on the fixing roller becomes high to shorten a life of the fixing member owing to a surface abrasion. Additionally, if the step portion is formed on the separation claw guide face, the toner gone around from the tip of the separation claw fills the step portion and then grows, and then the grown toner lump may be held between the separation claw and the fixing member.

### SUMMARY

In accordance with an aspect of the present disclosure, a fixing device includes a fixing member, a separation craw. The fixing member heats a toner image on a sheet while rotating around an axis. The separation claw comes into contact with a surface of the fixing member and separates the sheet from the surface of the fixing member. The separation claw has an opposing face facing the sheet. The opposing face has a tip end portion coming into contact with the surface of the fixing belt. The opposing face is formed to be asymmetry with respect to a conveyance direction along which the sheet is conveyed from the tip end portion.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inner structure of a color printer according to one embodiment of the present disclosure.

FIG. 2 is a cross sectional view showing a fixing device according to the embodiment of the present disclosure.

FIG. 3 is a plan view schematically showing the fixing device according to the embodiment of the present disclosure.

FIG. 4 is a perspective view showing a fixing roller, a separation unit, a moving mechanism and a biasing mechanism, in the fixing device according to the embodiment of the present disclosure.

FIG. 5 is a perspective view showing a part of the separation unit, in the fixing device according to the embodiment of the present disclosure.

FIG. 6 is a right side view explaining an operation of the moving mechanism, in the fixing device according to the embodiment of the present disclosure.

FIG. 7 is a cross sectional view showing the fixing roller and the separation unit, in the fixing device according to the embodiment of the present disclosure.

FIG. 8 is a perspective view showing a separation claw in the fixing device according to the embodiment of the present disclosure.

FIG. 9 is a right side view showing the separation claw and the fixing roller, in the fixing device according to the embodiment of the present disclosure.

FIG. 10 is a right side view showing the separation claw of a first modified example, in the fixing device according to the embodiment of the present disclosure.

FIG. 11 is a cross sectional view showing the fixing roller and the separation unit of a second modified example, in the fixing device according to the embodiment of the present disclosure.

FIG. 12 is a cross sectional view showing the separation claw and the fixing roller of the second modified example, in the fixing device according to the embodiment of the present disclosure.

### DETAILED DESCRIPTION

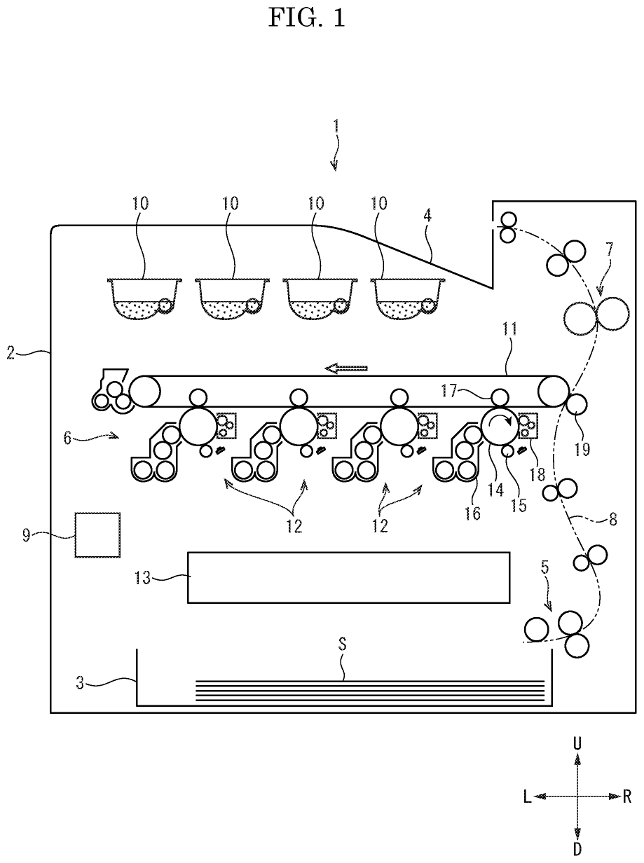

Hereinafter, an embodiment of the present disclosure will be described with reference to the attached figures. In the figures, “Fr” shows “front”, “Rr” shows “rear”, “L” shows “left”, “R” shows “right”, “U” shows “upper” and “D” shows “lower”. “Upstream”, “downstream” and these similar terms show “upstream”, “downstream” and their similar concept in a conveyance direction (a passing direction) of a sheet S.

[Outline of the color printer] With reference to FIG. 1, the color printer 1 as an example of the image forming apparatus will be described. FIG. is a front view schematically showing an inner structure of the color printer 1.

The color printer 1 includes an apparatus main body 2 constituting an approximately parallelepiped appearance. In the lower portion of the apparatus main body 2, a sheet feeding cassette 3 which stores a paper sheet S (a medium) is provided in an attachable and detachable manner. On the upper face of the apparatus main body 2, a discharge tray 4 is provided.

The color printer 1 is provided with a sheet feeding device 5, an image forming device 6 and a fixing device 7 which are stored in the apparatus main body 2. The sheet feeding device 5 is disposed at an upstream end portion of a conveyance path 8 extending from the sheet feeding cassette 3 to the discharge tray 4. The fixing device 7 is disposed in the downstream side portion of the conveyance path 8. The image forming device 6 is disposed between the sheet feeding device 5 and the fixing device 7 on the conveyance path 8.

The image forming device 6 includes four toner containers 10, an intermediate transferring belt 11, four drum units 12 and an optical scanning unit 13. The four toner containers 10 store toners (developers) of four colors (yellow, magenta, cyan and black). The drum unit 12 includes a photosensitive drum 14, a charge device 15, a development device 16, a primary transferring roller 17 and a cleaning device 18. The primary transferring roller 17 is disposed such that the intermediate transferring belt 11 is put between the photosensitive drum 14 and the primary transferring roller 17. With the right side portion of the intermediate transferring belt 11, a secondary transferring roller 19 comes into contact. Between the secondary transferring roller 19 and the intermediate transferring belt 11, a transferring nip is formed.

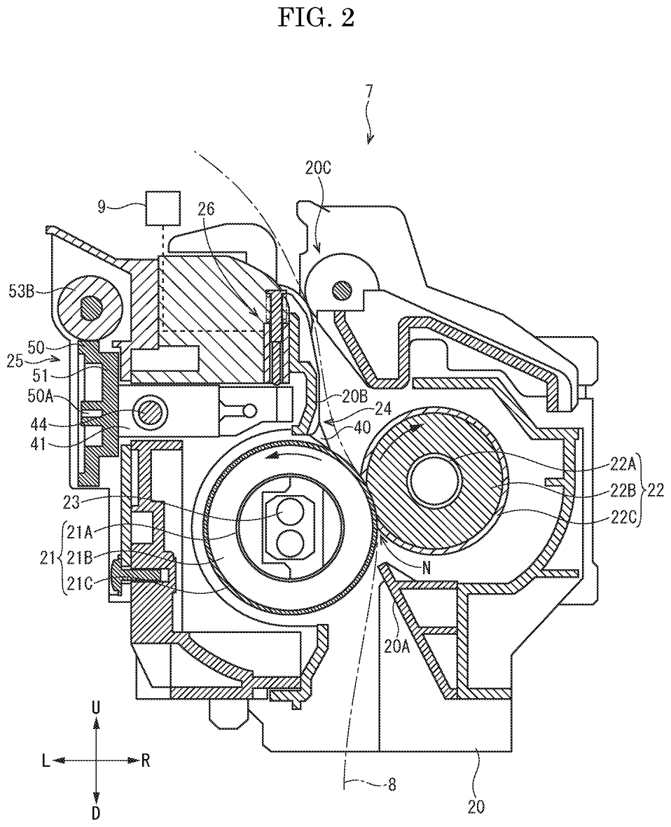

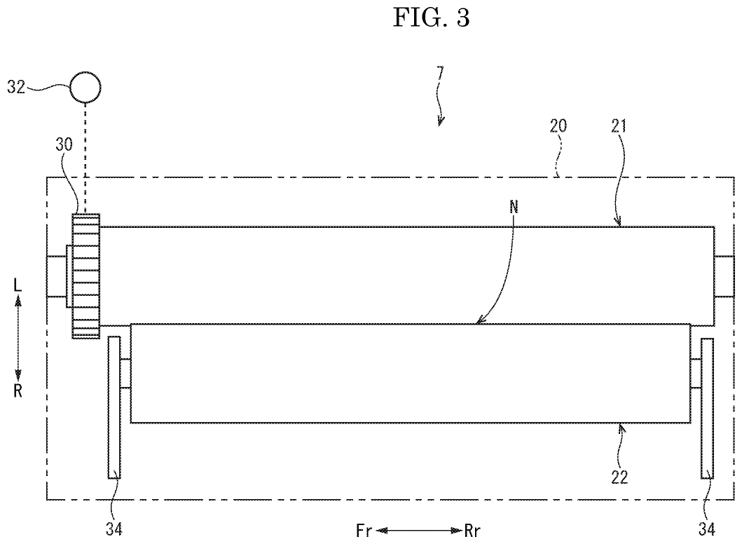

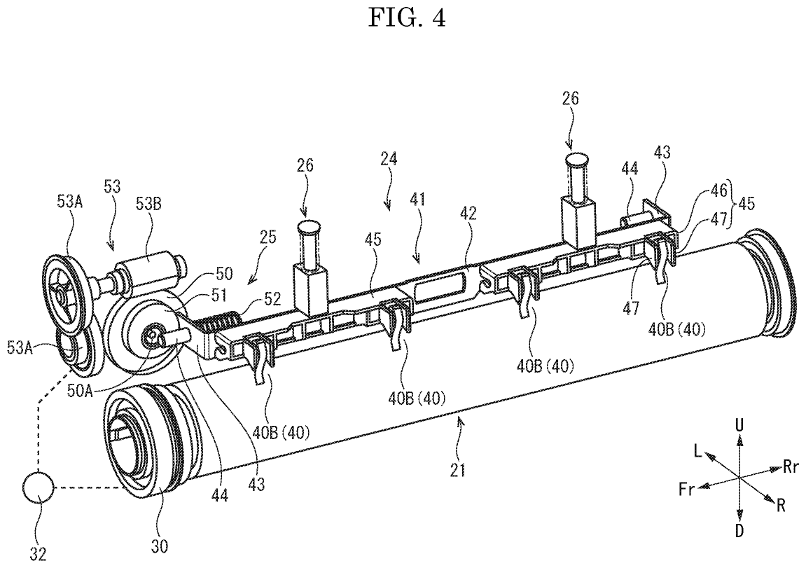

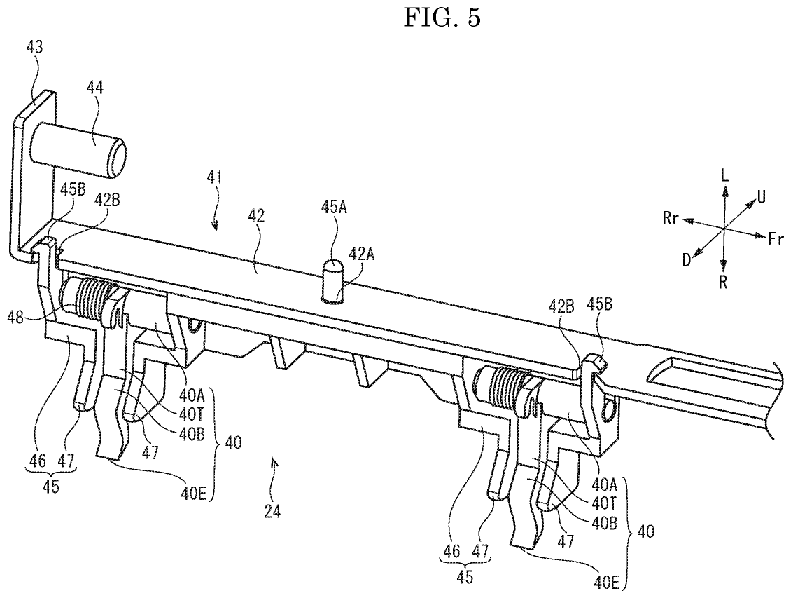

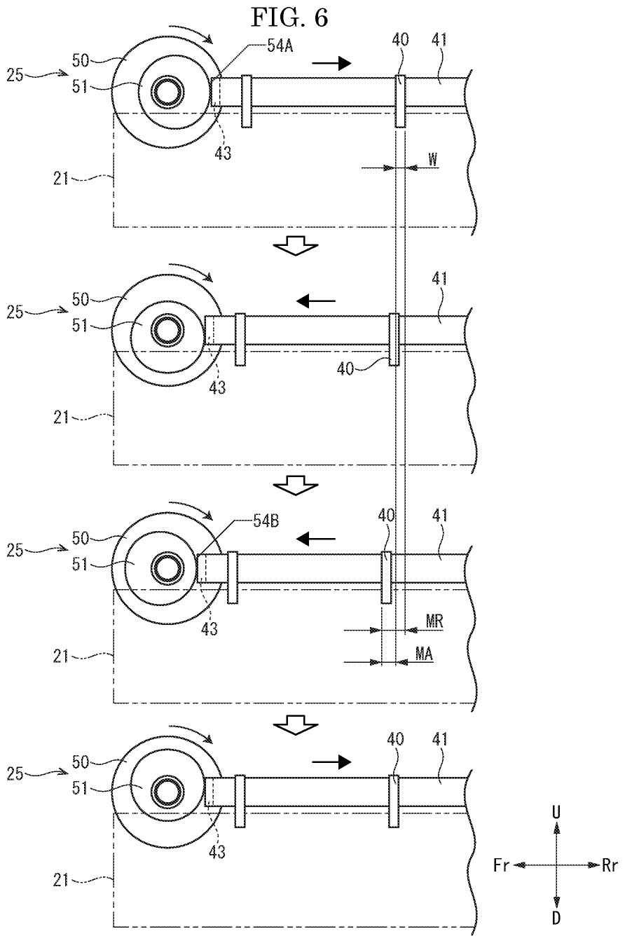

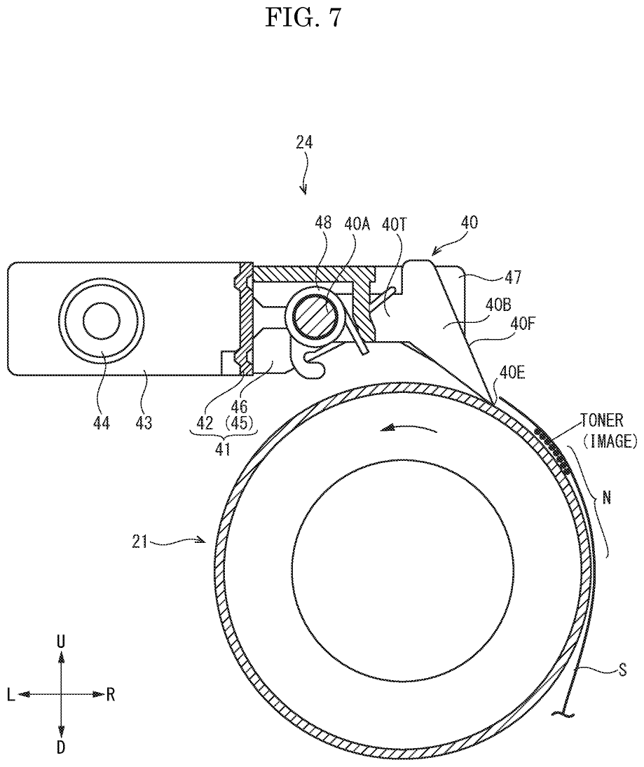

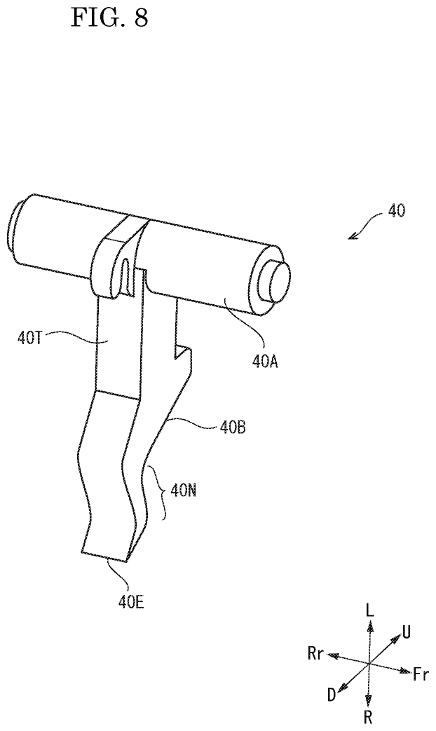

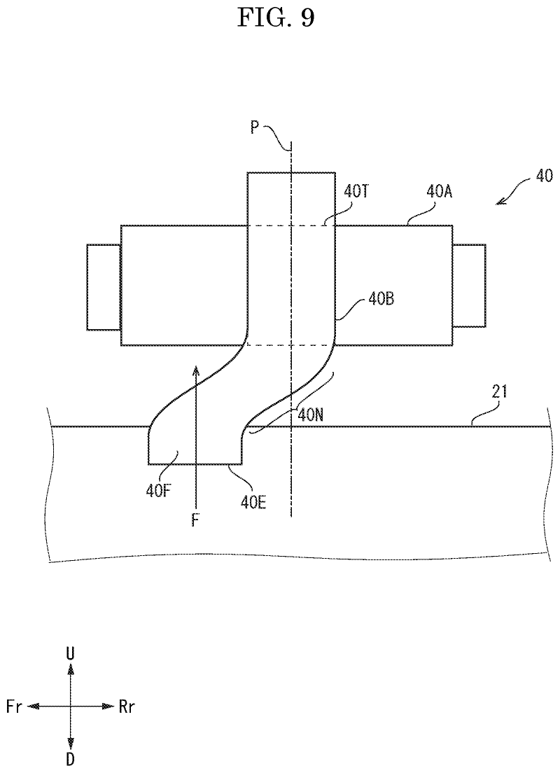

The color printer 1 is provided with a controller 9 which controls the above devices suitably to perform the following image forming operation. The charge device 15 charges the surface of the photosensitive drum 14. The photosensitive drum 14 is received with a scanning light emitted from the optical scanning unit 13 to carry an electrostatic latent image. The development device 16 employs the toner supplied from the corresponding toner container 10 and develops the electrostatic latent image on the photosensitive drum 14 in a toner image. The primary transferring roller 17 primarily transfers the toner image on the photosensitive drum 14 to the rotating intermediate transferring belt 11. The intermediate transferring belt 11 carries a full color toner image formed by overlapping the four color toner images while rotating. The sheet S is fed from the sheet feeding cassette 3 to the conveyance path 8 by the sheet feeding device 5. The secondary transferring roller 19 secondarily transfers the toner image on the intermediate transferring belt 11 to the sheet S passing through the transferring nip. The fixing device 7 heat-fixes the toner image on the sheet S. Then, the sheet S is discharged on the discharge tray 4. The cleaning device 18 removes the toner remaining on the photosensitive drum 14.

[The fixing device] Next, with reference to FIG. 2 to FIG. 9, the fixing device 7 will be described. FIG. 2 is a cross sectional view showing the fixing device 7. FIG. 3 is a plan view schematically showing the fixing device 7. FIG. 4 is a perspective view showing a fixing roller 21, a separation unit 24, a moving mechanism 25 and a biasing mechanism 26. FIG. 5 is a perspective view partially showing the separation unit 24. FIG. 6 is a right side view explaining an operation of the moving mechanism 25. FIG. 7 is a cross sectional view showing the fixing roller 21 and the separation unit 24. FIG. 8 is a perspective view showing a separation claw 40. FIG. 9 is a right side view showing the separation claw 40 and the fixing roller 21.

As shown in FIG. 2 and FIG. 3, the fixing device 7 includes a casing 20, the fixing roller 21, a pressing roller 22, a halogen heater 23, the separation unit 24, the moving mechanism 25 and the biasing mechanism 26. The casing 20 is supported by the apparatus main body 2. The fixing roller 21 and the pressing roller 22 are supported inside the casing 20 in a rotatable manner. The halogen heater 23 is provided in the hollow portion of the fixing roller 21. The separation unit 24, the moving mechanism 25 and the biasing mechanism 26 are provided on the downstream side of a contact portion (a pressing area N) of the fixing roller 21 to the pressing roller 22.

<The casing> The casing 20 is formed in an approximately parallelepiped shape long in the front-and-rear direction, and made of plate metal or heat resistant resin, for example. As shown in FIG. 2, inside the casing 20, a part of the conveyance path 8 along which the sheet S is conveyed is formed. In the lower portion of the casing 20, an introduction guide 20A which guides the sheet S to the pressing area N is provided. In the upper portion of the casing 20, a guide member 20B which guides the sheet S passed through the pressing area N to a discharge rollers pair 20C is provided. The discharge rollers pair 20C holds the sheet S passed through the pressing area N and conveys the sheet S to the downstream side.

<The fixing roller> As shown in FIG. 2 and FIG. 3, the fixing roller 21 as an example of a fixing member is formed in an approximately cylindrical shape long in the front-and-rear direction (an axial direction). The fixing roller 21 includes a fixing core metal 21A, a fixing elastic layer 21B provided on the outer circumferential face of the fixing core metal 21A and a fixing belt 21C which covers the fixing elastic layer 21B. To the front portion of the fixing roller 21, a fixing gear 30 is mounted (refer to FIG. 3). The fixing gear 30 is connected to a drive motor 32 (a pinion gear thereof) via a gear train (not shown) containing a plurality of gears.

<The pressing roller> The pressing roller 22 as an example of a pressing member is formed in an approximately cylindrical shape long in the front-and-rear direction (the axial direction), and disposed on the right side of the fixing roller 21. The pressing roller 22 includes a pressing core metal 22A, a pressing elastic layer 22B provided on the outer circumferential face of the pressing core metal 22A and a pressing release layer 22C which covers the pressing elastic layer 22B. Both the front and rear end portions of the pressing roller 22 (the pressing core metal 22A) are supported by a pair of movable frames 34 in a rotatable manner (refer to FIG. 3). The movable frames 34 are supported by the casing 20 in a turnable manner in the left-and-right direction, and connected to a pressure adjustment part (not shown) containing a spring, an eccentric cam and the others.

When the pressure adjustment part turns the movable frames 34 to a side of the fixing roller 21, the pressing roller 22 is pressed against the fixing roller 21 to form the compressed pressing area N between the fixing roller 21 and the pressing roller 22. On the other hand, when the pressure adjustment part turns the movable frames 34 in a direction separate from the fixing roller 21, the pressing of the pressing roller 22 against fixing roller 21 is released to form the decompressed pressing area N. The pressing area N shows an area from an upstream position where the pressure is 0 Pa through a position where the pressure is maximum to a downstream position where the pressure is 0 Pa again.

<The halogen heater> As shown in FIG. 2, the halogen heater 23 as an example of a heat source is formed in a rod-like shape long in the front-and-rear direction (the axial direction). The halogen heater 23 includes a halogen lamp which emits infrared light to heat the fixing roller 21. The present embodiment employs the halogen heater 23 as the heat source; however, a carbon heater or the like may be employed in place of the halogen heater 23. Alternatively, an induction heating type heater may be provided outside the fixing roller 21.

Inside the casing 20, a temperature sensor (not shown), such as a thermopile and a thermistor, which detects a surface temperature of the fixing roller 21 (or a temperature of the halogen heater 23) is provided. To the controller 9 of the color printer 1, the drive motor 32, the halogen heater 23, the temperature sensor and the others are electrically connected. The controller 9 controls the drive motor 32, the halogen heater 23, the temperature sensor and the others via various drive circuits.

<The separation unit> As shown in FIG. 2 and FIG. 4, the separation unit 24 is disposed above the fixing roller 21. As shown in FIG. 4 and FIG. 5, the separation unit 24 includes a support frame 41 disposed parallel to the fixing roller 21 and a plurality of (for example, four) separation claws 40 supported by the support frame 41. The separation claws 40 have the same structure, and one of them will be described hereinafter.

(The separation claw) As shown in FIG. 5, FIG. 7 to FIG. 9, the separation claw 40 has an approximately columnar turning shaft 40A extending in the front-and-rear direction, a body part 40T extending rightward from the axial center portion of the turning shaft 40A and a claw main body 40B extending in the right lower direction from the body part 40T. The turning shaft 40A, the body part 40T and the claw main body 40B are integrally formed by synthetic resin or metal, for example. As shown in FIG. 7, the tip end portion 40E of the claw main body 40B is formed in a wedge-like shape when viewed from the front side. The tip end portion 40E comes into contact with the surface of the fixing roller 21 on the downstream side of the pressing area N, and separates the sheet S passed through the pressing area N, from the surface of the fixing roller 21. The right side face (the face not facing the fixing roller 21) of the claw main body 40B is an opposing face 40F facing the sheet S when the sheet S is separated from the surface of the fixing roller 21.

As shown in FIG. 8 and FIG. 9, the opposing face 40F has a base end portion 40X on a side of the support frame 41 and a non-vertical portion 40N (an intermediate portion) between the base end portion 40X and the tip end portion 40E. The non-vertical portion 40N extends in a direction which is not perpendicular to the axial direction of the fixing roller 21. In other words, the non-vertical portion 40N is inclined with respect to a direction along which the sheet S is conveyed from the tip end portion 40E. Specifically, the opposing face 40F is formed to have a S-shaped curved shape as a whole such that it is curved forward below the body part 401 and then curved downward near the tip end portion 40E. Of the opposing face 40F, a portion between the forwardly curved portion below the body part 401 and the downwardly curved portion near the tip end portion 40E is the non-vertical portion 40N. By the non-vertical portion 40N, the tip end portion 40E is displaced with respect to the base end portion 40X in the axial direction of the fixing roller 21, and a space is formed on a downstream side of the tip end portion 40E in the conveyance direction. The opposing face 40F may be curved in an opposite direction to the direction shown in the figure.

In other words, the non-vertical portion 40N extends in a direction crossing to an imaginary face P (shown by a two-dotted chain line in FIG. 9) perpendicular to the axial direction of the fixing roller 21 (whose normal line is along the axial direction).

That is, the opposing face 40F is formed in an asymmetrical shape when viewed from a direction perpendicular to the axial direction of the fixing roller 21 (with respect to the conveyance direction along which the sheet is conveyed from the tip end portion 40E).

(The support frame) As shown in FIG. 4 and FIG. 5, the support frame 41 includes a metal plate member 42 and two box-shaped members 45. The metal plate member 42 is formed in a plate-like shape long in the front-and-rear direction, for example. The box-shaped member 45 is formed in an approximately parallelepiped shape long in the front-and-rear direction, and made of synthetic resin, for example.

(The metal plate member) Both the front and rear end portions of the metal plate member 42 are bent leftward (an opposite direction to the separation claw 40) to form a pair of bent pieces 43. To each bent piece 43, an approximately columnar support pin 44 extending from the rear side to the front side is fixed. The support pins 44 are disposed coaxially when viewed from the front side. The support pins 44 are supported by bearing portions (not shown) opened to the casing 20 in a slidable manner. The support frame 41 is provided in a slidable manner in the front-and-rear direction along the support pins 44 extending in the axial direction. The above described guide member 20B is disposed so as to cover the support frame 41 (refer to FIG. 2).

As shown in FIG. 5, the metal plate member 42 has a pair of through holes 42A opened to both the front and rear sides and two pairs of notches 42B formed on both the front and rear sides of each through hole 42A.

(The box-shaped member) The box-shaped member 45 has a projection 45A inserted into the through hole 42A of the metal plate member 42 and a pair of hooks 45B engaged with the pair of notches 42B of the metal plate member 42. The box-shaped member 45 is positioned to the metal plate member 42 by inserting the projection 45A into the through hole 42A and temporarily fixed to the metal plate member 42 by engaging the hooks 45B with the notches 42B. Then, the box-shaped member 45 is fastened to the metal plate member 42 by a screw (not shown). The two box-shaped members 45 are fastened to the front and rear end portions of the metal plate member 42 on both sides of the center portion in the front-and-rear direction (refer to FIG. 4).

As shown in FIG. 4 and FIG. 5, the box-shaped member 45 has a pair of bearing portions 46 formed in an approximately hollow box-like shape and two pairs of protection ribs 47 extending downward (toward the conveyance path 8 in the casing 20) from the bearing portions 46.

As shown in FIG. 5, the turning shaft 40A of the separation claw 40 is stored in the inside of the bearing portion 46, and both the end portions of the turning shaft 40A are supported by the front and rear walls of the bearing portion 46 in a rotatable manner. The protection ribs 47 are formed in positions adjacent to both the front and rear sides of the separation claw 40. Around the turning shaft 40A, a torsion coil spring 48 is wound. Both the end portions of the torsion coil spring 48 are engaged with the claw main body 40B and the bearing portion 46, and the torsion coil spring 48 presses the tip end portion 40E of the separation claw 40 against the surface of the fixing roller 21. In the present embodiment, the torsion coil spring 48 has a spring force set such that a load applied to the surface of the fixing roller 21 by the tip end portion 40E of the separation claw 40 (a contact pressure of the separation claw 40) is near 1.5 gf.

<The moving mechanism> As shown in FIG. 4, the moving mechanism 25 is disposed above the front portion of the fixing roller 21. The moving mechanism 25 includes an input gear 50, an eccentric cam 51, a biasing member 52 and the drive motor 32. The moving mechanism 25 has a function to reciprocate the separation claw 40 in the axial direction. The drive motor 32 is a device to rotate the fixing roller 21 and also a device constituting the moving mechanism 25.

(The input gear) The input gear 50 is a warm wheel that a plurality of teeth is formed around an outer circumferential face of a disk. On the axial center of the input gear 50, a gear shaft portion 50A is formed so as to extend in the left-and-right direction (a direction perpendicular to the fixing roller 21). The gear shaft portion 50A is supported by the casing 20 in a rotatable manner. The input gear 50 (the teeth thereof) is connected to the drive motor 32 (the pinion gear thereof) via a drive force transmission mechanism 53. The drive force transmission mechanism 53 contains a plurality of circular gears 53A (a spur gear, a stepped gear or the like) and a warm gear 53B. The final gear of the drive force transmission mechanism 53 is the warm gear 53B which is meshed with the input gear 50.

(The eccentric cam) The eccentric cam 51 has an approximately cylindrical shape, and is protruded forward from the right end face of the input gear 50. The eccentric cam 51 is disposed at a position where its axial center is displaced from the gear shaft portion 50A of the input gear 50. That is, the eccentric cam 51 is a so-called disk cam that a distance (an eccentric radius) between the rotational center (the gear shaft portion 50A) and the outer circumferential face is not constant along the circumferential direction. The outer circumferential face of the eccentric cam 51 forms a continuous cam face 54 containing a first cam face 54A having the maximum radius and a second cam face 54B having the minimum radius (refer to FIG. 6). The cam face 54 comes into contact with the front face of the bent piece 43 formed in the front end portion of the support frame 41. The input gear 50 and the eccentric cam 51 are made of metal material, for example.

(The biasing member) The biasing member 52 is a compressed coil spring, and disposed between the rear face of the bent piece 43 formed in the front end portion of the support frame 41 and the casing 20. The biasing member 52 has a function to bias the separation claw 40 (the bent piece 43 of the separation unit 24) toward the cam face 54 of the eccentric cam 51.

<The biasing mechanism> As shown in FIG. 2 and FIG. 4, the biasing mechanism 26 includes two compressed coil springs disposed above the two box-shaped members 45 and the others.

[An operation of the fixing device] Next, with reference to FIG. 2, an operation (a fixing operation) of the fixing device 7 will be described. In a case where the fixing operation is performed, the pressing roller 22 is pressed against the fixing roller 21 by the pressure adjustment part.

Firstly, the controller 9 controls the drive motor 32 and the halogen heater 23 to be driven. The fixing roller 21 is driven by the drive force of the drive motor 32 to be rotated, and the pressing roller 22 is driven by the fixing roller 21 to be rotated (refer to a solid narrow line arrow in FIG. 2). The halogen heater 23 heats the fixing roller 21 from the inside of the fixing roller 21. The temperature sensor outputs a detection signal representing a temperature of the fixing roller 21 (or the halogen heater 23) to the controller 9 through the input circuit. On receiving a detection signal showing that a temperature detected by the temperature sensor reaches a set temperature, the controller 9 starts to perform the above described image forming operation. The sheet S on which the toner image is transferred enters the inside of the casing 20, and the fixing roller 21 heats the toner (the toner image) on the sheet S passing through the pressing area N while rotating around the axis. The pressing roller 22 presses the toner on the sheet S passing through the pressing area N while rotating around the axis. Then, the toner is melted to be fixed on the sheet S.

[An operation of the separation claw] With reference to FIG. 7 and FIG. 9, an operation of the separation claw 40 will be described. The separation claws 40 come into contact with the surface of the fixing roller 21 and separate the sheet S, passed through the pressing area N, from the surface of the fixing roller 21. Then, the sheet S on which the toner image is fixed is discharged to the outside of the casing 20 and then stacked on the discharge tray 4. However, in the fixing device 7, a part of the toner transferred on the sheet S may be transferred to the fixing roller 21 from the sheet S without being fixed on the sheet S, and then transferred to the opposing face 40F of the separation claw 40 from the fixing roller 21. If the transferring of the toner is repeated, the toner is pushed out in a direction F shown in FIG. 9, passed through the non-vertical portion N and then dropped.

[An operation of the moving mechanism] With reference to FIG. 6, an operation of the moving mechanism 25 will be described.

The drive force of the drive motor 32 rotates the input gear 50 at almost a constant rotation speed via the drive force transmission mechanism 53. The moving mechanism 25 incorporates with the eccentric cam 51 rotating together with the input gear 50 and the biasing member 52 to reciprocate the separation unit 24 in the front-and-rear direction (the axial direction). In detail, the eccentric cam 51 rotates while bringing the cam face 54 indirectly contact with the separation claw 40 to reciprocate the separation claw 40 in the front-and-rear direction (the axial direction). Hereinafter, a case where the first cam face 54A comes into contact with the bent piece 43 of the support frame 41 is set to be “an initial state (0°)” (refer to the uppermost figure in FIG. 6), and detailed description will be provided.

In the initial state, the eccentric cam 51 pushes out the separation unit 24 rearward against the biasing force of the biasing member 52, and the separation unit 24 is disposed at the rearmost position. When the eccentric cam 51 rotates from the initial state, the bent piece 43 is slid relatively from the first cam face 54A to the second cam face 54B. In this case, because the eccentric radius of the cam face 54 is gradually decreased, the separation unit 24 biases by the biasing member 52 and then moves forward gradually (refer to the second figure from the uppermost figure in FIG. 6). When the eccentric cam 51 rotates at approximately 180° and the bent piece 43 reaches the second cam face 54B, the separation unit 24 is moved to the foremost position (refer to the third figure from the uppermost figure in FIG. 6).

When the eccentric cam 4 rotates further and the bent piece 43 is slid relatively from the second cam face 54B to the first cam face 54A, because the eccentric radius of the cam face 54 is gradually increased, the separation unit 24 is gradually moved rearward against the biasing force of the biasing member 52 (refer to the lowermost figure in FIG. 6). When the bent piece 43 reaches the first cam face 54A again, the separation unit 24 returns to the initial state (refer to the uppermost figure in FIG. 6).

As described above, when the eccentric cam 51 rotates once, the separation unit 24 reciprocates in the front-and-rear direction one time. When the eccentric cam 51 repeatedly rotates, the separation unit 24 (the separation claw 40) reciprocates repeatedly.

According to the fixing device 7 of the present embodiment, when the transferring of the toner from the fixing roller 21 to the opposing face 40F of the claw main body 40B is repeated, the toner is pushed out in the direction F in FIG. 9, passed through the non-vertical portion 40N and then dropped into the space on a downstream side of the tip end portion 40E in the conveyance direction. Accordingly, according to the fixing device 7 of the present embodiment, compared with a conventional case where the opposing face 40F extends in a direction perpendicular to the axial direction of the fixing roller 21, it becomes possible to inhibit the toner transferred to the separation claw 40 from the fixing roller 21 from being accumulated on the separation claw 40.

Additionally, according to the fixing device 7 of the present embodiment, because the separation claw 40 reciprocates in the axial direction by the moving mechanism 25, the separation claw 40 can scrape the sheet powder transferred to the fixing roller 21 from the sheet S within a wide range and then collect the sheet powder, so that a rate in amount of the sheet powder to the toner is increased. As a result, the toner accumulated on the opposing face 40F is easy to be broken. Then, according to the fixing device 7 of the present embodiment, compared with a case where the moving mechanism 25 is not provided, it becomes possible to inhibit the accumulation of the toner on the separation claw 40.

The above embodiment may be modified as follows.

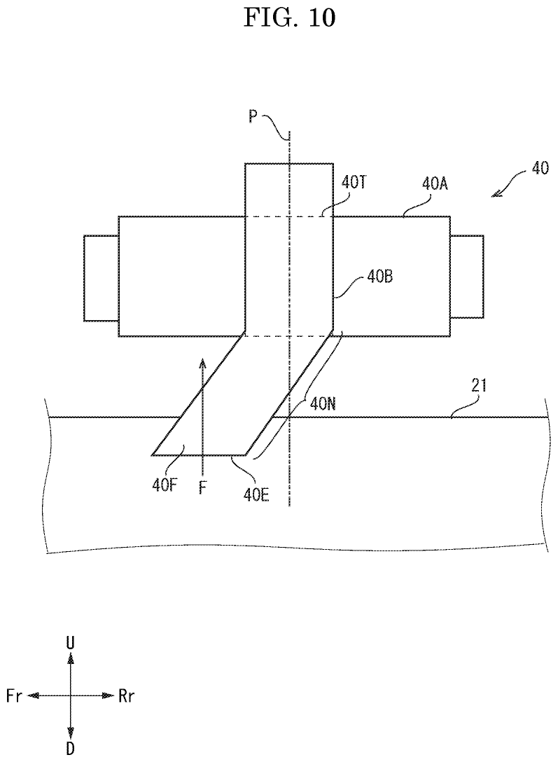

FIG. 10 is a right side view showing the separation claw 40 according to a first modified example of the above embodiment. As shown in FIG. 10, the separation claw 40 may be provided with the non-vertical portion 40N extending linearly in a direction not perpendicular to the axial direction of the fixing roller 21. According to the fixing device 7 of the modified example, in the same manner as the above embodiment, compared with a conventional case where the opposing face 40F extends in a direction perpendicular to the axial direction of the fixing roller 21, it becomes possible to inhibit the toner transferred to the separation claw 40 from the fixing roller 21 from being accumulated on the separation claw 40.

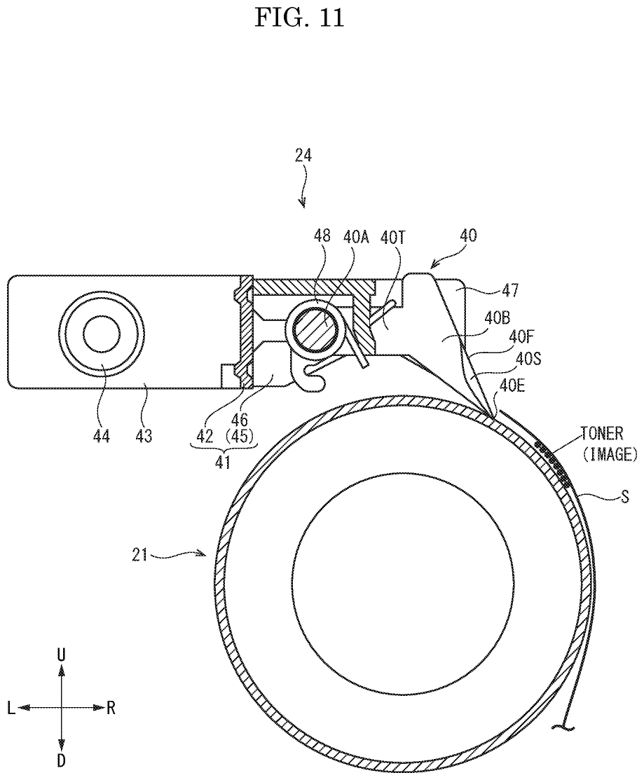

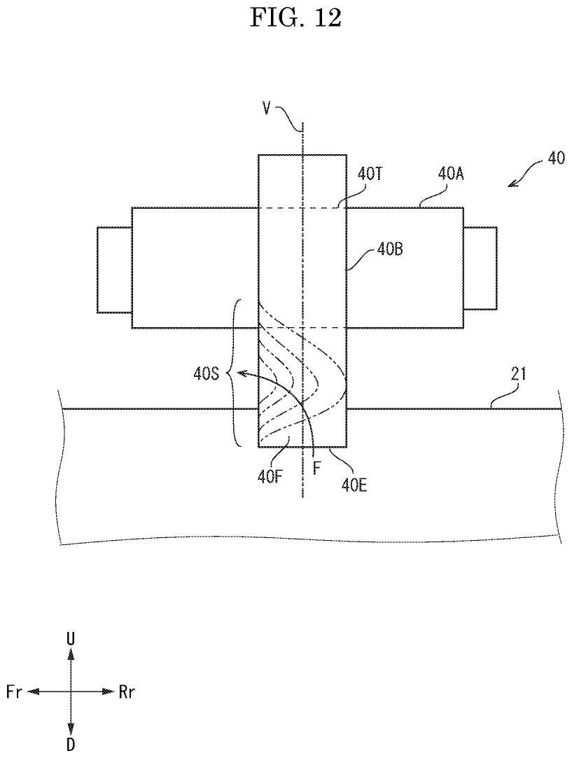

FIG. 11 and FIG. 2 are views showing a second modified example of the above embodiment. FIG. 11 is a sectional view showing the fixing roller 21 and the separation unit 24. FIG. 12 is a right side view showing the separation claw 40 and the fixing roller 21. FIG. 12 shows a contour line (a two-dotted chain line) indicating a change in height of an inclined portion 40S with respect to the opposing face 40F. As shown in FIG. 12, the opposing face 40F of the separation claw 40 may be provided with the inclined portion 40S not parallel to the axial direction of the fixing roller 21. In other words, the inclined portion 40S is formed to be recessed from one side edge (the rear side edge, in the example) in the axial direction of the fixing roller 21 to the other side edge (the front side edge, in the example). In the case, the opposing face 40F has the inclined portion 40S inclined downwardly from the front side to the rear side. However, the inclined face 40S may be inclined in an opposite direction to the above case.

That is, the opposing face 40F is formed so as to be asymmetry when viewed from a direction perpendicular to the axial direction of the fixing roller 21 (with respect to the conveyance direction).

According to the fixing device 7 of the modified example, when the transferring of the toner from the fixing roller 21 to the opposing face 40F of the claw main body 40B is repeated, the toner is pushed out in the direction F in FIG. 9, passed through the inclined portion 40S and then dropped. Accordingly, according to the fixing device 7 of the present embodiment, compared with a conventional case where the opposing face 40F is formed to be parallel to the axial direction of the fixing roller 21, it becomes possible to inhibit the toner transferred from the fixing roller 21 to the separation claw 40 from being accumulated on the separation claw 40.

The above embodiment or the first modified example may be combined with the second modified example. That is, the opposing face 40F of the separation claw 40 may have the non-vertical portion 40N and the non-vertical portion 40N may have the inclined portion 40S.

The fixing device 7 of the above embodiments includes the four separation claws 40; however, a number of the claw is not limited to the above embodiment. The fixing device 7 may include one or more separation claws 40. The moving mechanism 25 reciprocates the separation claw 40 in the front-and-rear direction via the support frame 41; however, the moving mechanism is not limited to the embodiment. The moving mechanism may have a configuration to bring the eccentric cam 51 directly contact with the separation claw 40 and to reciprocate the separation claw 40.

In the fixing device 7 according to the above embodiments, the moving mechanism 25 employs a cam mechanism containing the eccentric cam 51; however, the present disclosure is not limited to the above moving mechanism 25. In place of the cam mechanism (the eccentric cam 51 and the others), for example, a solenoid or a rack-and-pinion mechanism (not shown) may be employed as the moving mechanism. In this case, the plunger of the solenoid or the rack gear may be coupled to the separation unit 24 or the separation claw 40 to reciprocate the separation claw 40, preferably.

In the fixing device 7 according to the above embodiments, the drive motor 32 drives the fixing roller 21 to be rotated; however, the present disclosure is not limited thereto. The drive motor 32 may drive the pressing roller 22 to be rotated. The pressure adjustment part displaces the pressing roller 22 to change the pressure of the pressing area N; however, the present disclosure is not limited thereto. The pressure adjustment part may displace the fixing roller 21 to change the pressure of the pressing area N.

In the fixing device 7 according to the above embodiments, the fixing roller 21 has a configuration where the fixing elastic layer 21B is provided around the fixing core metal 21A and the fixing belt 21C are wound around the fixing elastic layer 21B; however, the present disclosure is not limited thereto. For example, the fixing member may be an endless belt and a pad pressing the fixing belt against the pressing roller 22 from the inside may be provided (not shown).

The embodiments were described in a case of applying the configuration of the present disclosure to the color printer 1. On the other hand, in another embodiment, the configuration of the disclosure may be applied to another image forming apparatus, such as a monochromatic printer, a cloying machine, a facsimile or a multifunction peripheral.

Although the present disclosure described the specific embodiment, the present disclosure is not limited to the embodiment. It is to be noted that one skilled in the art can modify the embodiment without departing from the scope and spirit of the present disclosure.

1. A fixing device comprising:
a fixing member which heats a toner image on a sheet while rotating around an axis; and
a separation claw which comes into contact with a surface of the fixing member and separates the sheet from the surface of the fixing member,
wherein the separation claw has an opposing face facing the sheet, the opposing face has a tip end portion coming into contact with the surface of the fixing belt, and the opposing face is formed to be asymmetry with respect to a conveyance direction along which the sheet is conveyed from the tip end portion.

2. The fixing device according to claim 1, further comprising a support frame by which the separation claw is supported,
wherein the opposing face has:
a base end portion at a side of the support frame; and
an intermediate portion provided between the base end portion and the tip end portion and inclined with respect to the conveyance direction,
wherein the base end portion is displaced with respect to the tip end portion in an axial direction of the fixing member perpendicular to the conveyance direction, and
a space is formed on a downstream side of the tip end portion in the conveyance direction.

3. The fixing device according to claim 3,
wherein the intermediate portion is formed to be recessed from one side to the other side in the axial direction of the fixing member.

4. The fixing device according to claim 1,
wherein the opposing face has an inclined portion formed to be recessed from one side to the other side in an axial direction of the fixing member.

5. The fixing device according to claim 1, comprising a moving mechanism which reciprocates the separation claw in an axial direction of the fixing member.

6. An image forming apparatus comprising:
an image forming device which forms a toner image on a sheet; and
the fixing device according to claim 1, which fixes the toner image on the sheet.
